(19) United States
(12) Patent Application Publication
(10) Pub. No.: US 2006/0173126 A1
(43) Pub. Date: Aug. 3, 2006

(54) Room temperature curable organopolysiloxane compositions

(75) Inventor: Tadashi Araki, Gunma-ken (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/344,473

(22) Filed: Feb. 1, 2006

(30) Foreign Application Priority Data
Feb. 2, 2005 (JP) 2005-025885

(51) Int. Cl. C08L 83/04; B32B 27/00

(52) U.S. Cl. 524/588; 524/863

(57) ABSTRACT

An RTV organopolysiloxane composition is provided comprising (A) an organopolysiloxane having the formula: HO(R¹₂SiO)ₓH wherein R¹ is a monovalent hydrocarbon group and x is an integer of at least 10, (B) an alkoxysilane compound having on the average at least two silicon-bonded hydrolyzable groups and/or a partial hydrolyzate thereof, (C) organoxy titanium, and (D) an organic compound having at least one hydroxyl group bonded to a benzene ring. The color of the composition tinted with components (C) and (D) fades or changes upon curing of the composition, by which a degree of curing is visually observable. The composition has improved storage stability and resin adhesion.

### CROSS-REFERENCE TO RELATED APPLICATION

This non-provisional application claims priority under 35 U.S.C. §119(a) on Patent Application No. 2005-025885 filed in Japan on Feb. 2, 2005, the entire contents of which are hereby incorporated by reference.

This invention relates to room temperature curable organopolysiloxane compositions, and more particularly, to room temperature curable organopolysiloxane compositions which cure by moisture and fade or change in color upon moisture crosslinking so that a degree of curing is visually observable and which have improved storage stability and resin adhesion.

### BACKGROUND OF THE INVENTION

Silicone compositions of the condensation cure type which crosslink and cure through reaction with air-borne moisture are well known in the art. Among others, those compositions of the type that cure while liberating alcohol are preferentially used in sealing, bonding and coating of electric and electronic equipment, because they do not cause corrosion to metals. Silicone compositions of this type are typically composed of a compound containing silicon having a hydrolyzable group bonded thereto on the molecule such as an alkoxysilane, and a moisture curing catalyst such as a titanium compound. Upon contact with air-borne moisture, these compositions cure into elastomers. One typical composition of the alcohol type is described in JP-B 39-27643 as comprising an organopolysiloxane end-blocked with hydroxyl groups, an alkoxysilane, and an organic titanium compound. Also JP-A 55-43119 discloses a composition comprising an organopolysiloxane end-blocked with alkoxysilyl groups, an alkoxysilane, and alkoxy titanium. Lately, JP-B 7-39547 discloses a composition which remains fully stable during storage in the sealed state.

However, all the compositions of JP-B 39-27643, JP-A 55-43119, and JP-B 7-39547 suffer from a problem of difficult cure monitoring. Since crosslinking reaction does not occur rapidly, a degree of curing cannot be identified by observation of their outer appearance. If a degree of curing is ascertained by finger touch, the appearance of the cured composition is fouled. It would be desirable to have a method of determining a degree of curing of a curable composition. Also for the curable composition used as an adhesive, if the members bonded therewith were moved in order to confirm whether the composition has cured, an inherent bond strength would be lost. It is thus unacceptable to confirm the cure by this method. Additionally, the compositions of JP-B 39-27643 and JP-A 55-43119 are less stable during storage, and the composition of JP-B 7-39547 is less adhesive to resins.

JP-A 2003-128942 discloses a room temperature curable composition comprising (A) an organic compound containing at least one silicon atom having a hydroxyl or hydrolyzable group per molecule, (B) a moisture curing catalyst, (C) a compound having alkalinity, (D) a benzotriazole derivative, (E) a component in which the benzotriazole derivative is dissolvable, wherein the color of the composition fades away concurrently with moisture curing. The combination of the alkaline compound with the benzotriazole derivative and the benzotriazole derivative-soluble component is necessary to achieve a decolorizing effect.

### DISCLOSURE OF THE INVENTION

An object of the present invention is to provide a room temperature curable organopolysiloxane composition which cures by moisture and fades or changes in color at the same time so that a degree of curing is visually observable without detracting from moisture curability and which has improved storage stability and resin adhesion.

The inventor has discovered that using an organopolysiloxane selected from the general formulae (1), (2) and (3), shown below, an alkoxysilane compound having on the average at least two silicon-bonded hydrolyzable groups per molecule and/or a partial hydrolyzate thereof, an organoxy titanium catalyst having the general formula (5), shown below, and an organic compound having at least one hydroxyl group bonded to a benzene ring per molecule, a room temperature curable organopolysiloxane composition is obtainable which fades or changes in color at the same time as moisture crosslinking so that a degree of curing is visually observable and which has improved storage stability and resin adhesion.

With respect to the mechanism through which the color of the composition fades or changes in response to moisture curing, it is believed that ester exchange occurs between the alkoxy moiety of the organoxy titanium and the organic compound having at least one hydroxyl group bonded to a benzene ring per molecule, to form a linkage having the general formula (6): 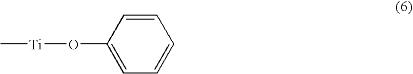
which develops a red to pale yellow color, and that as the composition becomes more elastomeric through moisture curing, the titanium catalyst undergoes more hydrolysis until it becomes titanium oxide where the color fades out.

As described above, the room temperature curable composition of JP-A 2003-128942 should contain an alkaline compound such as an amine, a benzotriazole derivative and a benzotriazole derivative-soluble component in order to achieve the decolorizing effect upon moisture curing whereas the composition of the invention decolorizes or color-changes without a need for alkaline compounds such as amines, organic solvents for dissolving the benzotriazole derivatives, plasticizers and the like. In this sense, the present invention relies on the decolorizing mechanism which is completely different from JP-A 2003-128942.

Accordingly, the present invention provides a room temperature curable organopolysiloxane composition comprising

(A) 100 parts by weight of at least one organopolysiloxane selected from the group consisting of an organopolysiloxane having the general formula (1):
HO(R¹₂SiO)ₓH (1)
wherein R¹ is each independently a substituted or unsubstituted monovalent hydrocarbon group and x is an integer of at least 10, an organopolysiloxane having the general formula (2): 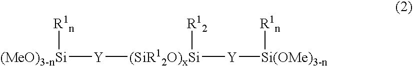
wherein R¹ and x are as defined above, Me is methyl, Y is an oxygen atom or an alkylene group of 1 to 5 carbon atoms, and n is independently an integer of 0 or 1, and an organopolysiloxane having the general formula (3): 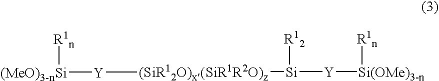
wherein R¹, Me, Y and n are as defined above, R² is a branch chain containing a hydrolyzable group having the general formula (4):
−Y—Si(OMe)₃₋ₙ (4)
wherein Y, Me and n are as defined above, x′ is an integer of at least 9, z is an integer of at least 1, and x′+z=x,

(B) 0.1 to 20 parts by weight of an alkoxysilane compound having on the average at least two silicon-bonded hydrolyzable groups per molecule or a partial hydrolyzate thereof or a mixture thereof,

(C) 0.5 to 15 parts by weight of an organoxy titanium compound having the general formula (5):
Ti(OR³)₄ (5)
wherein R³ is each independently a monovalent hydrocarbon group of 2 to 10 carbon atoms,

(D) 0.01 to 10 parts by weight of an organic compound having at least one hydroxyl group bonded to a benzene ring per molecule, and

(E) 0 to 10 parts by weight of a silane coupling agent,

wherein the color of the composition tinted with components (C) and (D) fades or changes upon curing of the composition, by which a degree of curing is visually observable.

### BENEFITS OF THE INVENTION

The room temperature curable organopolysiloxane composition of the invention fades or changes its color at the same time as moisture crosslinking so that a degree of curing is determinable by visual observation while it possesses improved storage stability and resin adhesion.

### DESCRIPTION OF THE PREFERRED EMBODIMENTS

Component (A) which serves as a base polymer in the inventive composition is at least one organopolysiloxane selected from the group consisting of an organopolysiloxane having the general formula (1):
HO(R¹₂SiO)ₓH (1)
wherein R¹ is each independently a substituted or unsubstituted monovalent hydrocarbon group and x is an integer of at least 10, an organopolysiloxane having the general formula (2): 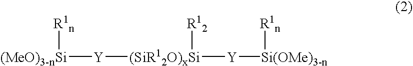
wherein R¹ and x are as defined above, Me is methyl, Y is an oxygen atom or an alkylene group of 1 to 5 carbon atoms, and n is independently on each side an integer of 0 or 1, and an organopolysiloxane having the general formula (3): 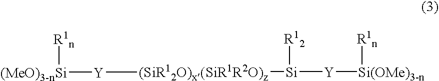
wherein R¹, Me, Y and n are as defined above, R² is a branch chain containing a hydrolyzable group having the general formula (4):
—Y—Si(OMe)₃₋ₙ (4)
wherein Y, Me and n are as defined above, x′ is an integer of at least 9, z is an integer of at least 1, and x′+z=x.

Component (A) should preferably have a viscosity of 100 to 1,000,000 mPa·s at 25° C. With a viscosity of less than 100 mPa·s, the composition cures into an elastomer which may not be endowed with good physical properties, especially flexibility and elongation. With a viscosity of more than 1,000,000 mPa·s, the composition may become too viscous to discharge when it is applied. The viscosity of component (A) is more preferably from 500 to 500,000 mPa·s and most preferably from 5,000 to 100,000 mPa·s at 25° C. Thus, x, x′ and z are selected so as to give a viscosity within the above-defined range. It is noted that the viscosity is measured by a rotational viscometer.

In formulae (1), (2) and (3), R¹ is independently selected from substituted or unsubstituted monovalent hydrocarbon groups, preferably having 1 to 10 carbon atoms, more preferably 1 to 6 carbon atoms, for example, alkyl groups such as methyl, ethyl and propyl, alkenyl groups such as vinyl, aryl groups such as phenyl, cycloalkyl groups such as cyclohexyl, and substituted forms of the foregoing in which some hydrogen atoms are replaced by halogen atoms, such as 3,3,3-trifluoropropyl. Of these, methyl, vinyl, and 3,3,3-trifluoropropyl are preferred, with the methyl being most preferred. A plurality of R¹ in formulae (1), (2) and (3) may be the same or different.

Y is an oxygen atom or an alkylene group of 1 to 5 carbon atoms. Exemplary of the alkylene group are methylene, ethylene, propylene, butylene and hexylene. Of these, oxygen and ethylene are preferred.

Component (B) is an alkoxysilane compound having on the average at least two silicon-bonded hydrolyzable groups per molecule or a partial hydrolyzate thereof or a mixture thereof.

Examples of the alkoxysilane compound having on the average at least two silicon-bonded hydrolyzable groups per molecule include alkoxysilanes such as methyltrimethoxysilane, vinyltrimethoxysilane, phenyltrimethoxysilane, methyltriethoxysilane, vinyltriethoxysilane, phenyltriethoxysilane, tetramethoxysilane, and tetraethoxysilane, and partial hydrolytic condensates of the foregoing silanes. These may be used alone or in admixture. When it is desired that the rubber elastomer after curing be endowed with low modulus, a tri- or tetra-functional alkoxysilane may be used in combination with a difunctional alkoxysilane such as diphenyldimethoxysilane.

Component (B) is used in amounts of 0.1 to 20 parts by weight, preferably 1 to 10 parts by weight per 100 parts by weight of component (A). Less than 0.1 pbw of component (B) fails to achieve sufficient crosslinking or form a composition having the desired rubber elasticity whereas more than 20 pbw of component (B) tends to form cured compositions with low mechanical properties.

Component (C) is an organoxy titanium compound. It serves as a catalyst for accelerating cure reactions of the inventive composition and is essential for the composition to develop a color. It has the general formula (5):
Ti(OR³) (5)
wherein R³ is independently selected from monovalent hydrocarbon groups of 2 to 10 carbon atoms, such as alkyl groups. Examples of the organoxy titanium include tetraethyltitanate, tetrapropyltitanate, tetrabutyltitanate, tetra(2-ethylhexyl)titanate, and tetra-tert-butyltitanate. The organoxy moiety of the organoxy titanium may be either straight or branched while a plurality of organoxy moieties or alkoxy groups may be the same or different.

Component (C) is added in amounts of 0.5 to 15 parts by weight, preferably 3 to 10 parts by weight per 100 parts by weight of component (A). Outside the range, less amounts of component (C) achieve less of the desired color developing effect, fail to ensure storage stability, and require a longer time until the inventive composition is fully cured. Inversely, excessive amounts of component (C) give rise to problems including slow or no decolorizing, rapid surface curing, retarded depth curing, and poor storage stability.

Component (D) is an organic compound having at least one hydroxyl group bonded to a benzene ring per molecule. It is essential for the composition to develop a color. The number of hydroxyl groups bonded to a benzene ring is at least one, preferably 1 to 5, most preferably 1 or 2. Examples include phenols and cresols such as phenol, p-vinylphenol, 4,4′-butylidene-bis(3-methyl-6-tert-butylphenol), 2,2′-methylene-bis(4-methyl-6-tert-butylphenol), 2,2′-methylene-bis(4-ethyl-6-tert-butylphenol), p-cresol, and 2,6-di-tert-butyl-p-cresol, and hydroquinones such as hydroquinone, 2,5-di-tert-amylhydroquinone, and 2,5-di-tert-butylhydroquinone.

Component (D) is added in amounts of 0.01 to 10 parts by weight, preferably 0.05 to 5 parts by weight per 100 parts by weight of component (A). Outside the range, less amounts of component (D) fail to achieve the desired color developing effect. Inversely, excessive amounts of component (D) give rise to the problem of slow or no decolorizing, and lead to uncured compositions with poor storage stability and cured compositions with poor mechanical properties.

When the organoxy titanium as component (C) and the organic compound having at least one hydroxyl group bonded to a benzene ring per molecule as component (D) are previously mixed to give a premix in which a linkage having the general formula (6): 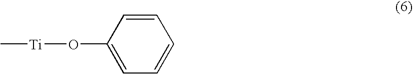
is formed, and then compounded with the other components, the resulting composition remains unchanged with respect to the color developing and fading effects. It is thus acceptable to use a premix of components (C) and (D). In this embodiment, the amounts of components (C) and (D) in the composition should fall in the above-defined ranges.

Component (E) is a silane coupling agent which functions as a tackifier in the inventive composition. Any of well-known silane coupling agents may be advantageously used including vinylsilane coupling agents, (meth)acrylic silane coupling agents, epoxysilane coupling agents, aminosilane coupling agents, and mercaptosilane coupling agents. Examples include vinyltris(β-methoxyethoxy)silane, γ-methacryloxypropyltrimethoxysilane, β-(3,4-epoxycyclohexyl)ethyltrimethoxysilane, γ-glycidoxypropyltrimethoxysilane, γ-glycidoxypropylmethyldiethoxysilane, N-β-(aminoethyl)-γ-aminopropyltrimethoxysilane, γ-aminopropyltriethoxysilane, and γ-mercaptopropyltrimethoxysilane.

Component (E) is compounded in amounts of 0 to 10 parts by weight, preferably 0.1 to 5 parts by weight per 100 parts by weight of component (A). The silane coupling agent need not be used if the composition even in the absence of silane coupling agent adheres to a substrate, depending on a particular type of filler and substrate. When the silane coupling agent is used, more than 10 pbw is economically disadvantageous.

In addition to the aforementioned components (A) to (E), at least one filler may be added as component (F) to the inventive composition. Component (F) is a reinforcing or non-reinforcing filler for imparting rubber physical properties to the inventive composition. In one embodiment, inorganic fillers in fine powder form may be added for improving the flow of the composition prior to curing and imparting necessary mechanical properties to the rubbery elastomer after curing. Examples of suitable inorganic fillers include finely divided quartz, fumed silica, precipitated silica, calcium carbonate, fumed titanium dioxide, diatomaceous earth, aluminum hydroxide, microparticulate alumina, magnesia, zinc oxide, and zinc carbonate. They may be surface treated with silanes, silazanes, low-degree-of-polymerization siloxanes, and organic compounds. Of these, fumed silica and calcium carbonate and surface-treated forms thereof are preferred.

Typically component (F) is compounded in amounts of 1 to 500 parts by weight per 100 parts by weight of component (A). Less than 1 pbw of the filler may fail to provide the desired composition due to shortage of rubber strength. With more than 500 pbw of the filler used, the composition may have too high a viscosity and become difficult to work. The preferred amount of the filler is 5 to 200 parts by weight.

In a preferred embodiment, an inert silicone fluid, preferably a polydimethylsiloxane capped with trimethylsilyl groups at both ends is compounded as component (G) in the inventive composition. Compounding component (G) improves some properties like working efficiency and thread breakup and modifies rubber physical properties after curing.

Component (G) should preferably have a viscosity of 5 to 50,000 mPa·s, more preferably 50 to 5,000 mPa·s at 25° C. Component (G) is preferably compounded in amounts of 0 to 200 parts by weight, especially 5 to 100 parts by weight per 100 parts by weight of component (A).

In the room temperature curable organopolysiloxane composition of the invention, other additives such as mildew-proofing agents, flame retardants, heat resistance modifiers, thixotropic agents, adhesion promoters, curing promoters, and pigments may be added as long as they do not adversely affect the objects of the invention.

The inventive composition is obtainable by mixing components (A) to (E) and optionally components (F), (G) and other additives in moisture-shielded conditions. The composition thus obtained can be handled as a one package type RTV organopolysiloxane composition in that it is received in a sealed container for storage and on use, exposed to air-borne moisture whereupon it cures into a rubbery elastomer.

The inventive composition may find use in various fields, for example, as sealants for buildings, sealants for electric and electronic parts, adhesives, moisture-proof coatings, and coatings and adhesives for fibrous, glass, metal, and plastic articles.

### EXAMPLE

Synthesis Examples, Examples and Comparative Examples are given below for further illustrating the invention, but the invention is not limited thereto. All parts are by weight. Viscosity is a measurement at 25° C. by a rotational viscometer.

### Synthesis Example 1

A three-necked flask (internal volume 2 liters) equipped with a thermometer, stirrer and condenser was charged with 2,500 g of α,ω-dimethylvinyl-dimethylpolysiloxane of the formula: 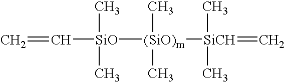
having a viscosity of 30,000 mPa·s, 400 g of toluene, 11.9 g of trimethoxysilane [HSi(OCH₃)₃], and 1.0 g of a 50% toluene solution of chloroplatinic acid as a catalyst, which were stirred for 9 hours at room temperature in a N₂ stream. Thereafter, by heating at 100° C. in a vacuum of 10 mmHg, the toluene as a diluent and the excess of trimethoxysilane were distilled off. There was obtained 2,350 g of a colorless clear liquid having a viscosity of 40,000 mPa·s and a nonvolatile content of 99.9%. When this liquid was mixed with tetrapropyl titanate in a ratio of 100:1, it did not thicken immediately and cured after one day. This suggests the addition of trimethoxysilane to vinyl groups at polymer ends. This polymer is designated Polymer A and has the formula shown below.

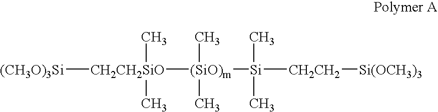

### Example 1

A composition was prepared by mixing 100 parts of Polymer A with 20 parts of fumed silica surface treated with dimethyldichlorosilane (R972, Nippon Aerosil Co., Ltd.), and further mixing them with 7 parts of vinyltrimethoxysilane, 2 parts of tetra(2-ethylhexyl)titanate and 1 part of 2,6-di-tert-butyl-p-cresol (abbreviated as BHT) under moisture-shielded conditions until uniform.

### Example 2

A composition was prepared by the same procedure as in Example 1 except that 1 part of 4,4′-butylidene-bis(3-methyl-6-tert-butylphenol) (Antage W300, Kawaguchi Chemical Industry Co., Ltd.) was used instead of BHT.

### Example 3

A composition was prepared by the same procedure as in Example 1 except that 1 part of 2,5-di-tert-amylhydroquinone (Antage DAH, Kawaguchi Chemical Industry Co., Ltd.) was used instead of BHT.

### Comparative Example 1

A composition was prepared by the same procedure as in Example 1 except that BHT was omitted.

### Comparative Example 2

A composition was prepared by the same procedure as in Example 1 except that 0.2 part of dibutyltin bis(benzylmaleate) was used instead of tetra(2-ethylhexyl)titanate.

The compositions of Examples and Comparative Examples were shaped into sheets of 2 mm thick while the color developed by the compositions was visually observed. Then the compositions were cured in an atmosphere of 23±2° C. and RH 50±5% for 7 days, after which the physical properties (hardness, elongation at break, tensile strength) of the rubber sheets were measured according to JIS K6249. At this point, the color fading of the compositions was visually observed. Separately, the RTV compositions were coated onto resin adherends of 25×100×2 mm (thick) and held at room temperature until rubber elastomers were obtained. The adhesion of the cured coating to the adherend was examined by pulling the cured coating. The resin adherends used herein included those of ABS resin, polycarbonate (PC) resin, and acrylic resin, which are commonly used as building material. The resin adhesion was rated with symbol “◯” for satisfactory adhesion and “×” for unacceptable adhesion.

A storage stability test was carried out by filling a cartridge with the uncured composition, heating the package in a dryer at 70° C., discharging the composition from the package, and allowing the composition to cure in an atmosphere of 23±2° C. and RH 50±5% for 7 days. Like the fresh compositions, the aged compositions (or rubbers) were measured for physical properties and adhesion.

The results of Examples and Comparative Examples are shown in Table 1.

TABLE 1

| | Example | | | Comparative Example | |
|---|---|---|---|---|---|
| | 1 | 2 | 3 | 1 | 2 |
| Polymer | A | A | A | A | A |
| | (100 pbw) | (100 pbw) | (100 pbw) | (100 pbw) | (100 pbw) |
| Fumed silica | R972 | R972 | R972 | R972 | R972 |
| | (20 pbw) | (20 pbw) | (20 pbw) | (20 pbw) | (20 pbw) |
| Crosslinker | vinyltri- | vinyltri- | vinyltri- | vinyltri- | vinyltri- |
| | methoxysilane | methoxysilane | methoxysilane | methoxysilane | methoxysilane |
| | (7 pbw) | (7 pbw) | (7 pbw) | (7 pbw) | (7 pbw) |
| Catalyst | tetra(2-ethyl- | tetra(2-ethyl- | tetra(2-ethyl- | tetra(2-ethyl- | dibutyltin |
| | hexyl)titanate | hexyl)titanate | hexyl)titanate | hexyl)titanate | bis(benzyl- |
| | (2 pbw) | (2 pbw) | (2 pbw) | (2 pbw) | maleate) |
| | | | | | (0.2 pbw) |
| Organic compound | BHT | Antage W300 | Antage DAH | — | BHT |
| | (1 pbw) | (1 pbw) | (1 pbw) | | (1 pbw) |

Initial physical properties

| | | | | | |
|---|---|---|---|---|---|
| Composition's color | pale yellow | orange | red | colorless | colorless |
| Cured composition's color | colorless | colorless | pale yellow | colorless | colorless |
| Tack-free time (min) | 3 | 3 | 3 | 3 | 3 |
| Slump (mm) | 0 | 0 | 0 | 0 | 0 |
| Hardness (Durometer A) | 48 | 50 | 49 | 49 | 50 |
| Elongation at break (%) | 560 | 520 | 580 | 560 | 560 |
| Tensile strength (MPa) | 3.6 | 3.8 | 4.0 | 3.5 | 3.6 |

Resin adhesion

| | | | | | |
|---|---|---|---|---|---|
| ABS resin | ◯ | ◯ | ◯ | ◯ | ◯ |
| PC resin | ◯ | ◯ | ◯ | ◯ | X |
| Acrylic resin | ◯ | ◯ | ◯ | ◯ | X |

Aged physical properties

| | | | | | |
|---|---|---|---|---|---|
| Tack-free time (min) | 6 | 6 | 7 | 6 | 30 |
| Hardness (Durometer A) | 45 | 49 | 47 | 45 | 30 |
| Elongation at break (%) | 600 | 550 | 570 | 520 | 250 |
| Tensile strength (MPa) | 3.8 | 3.7 | 3.5 | 3.7 | 1.2 |

Japanese Patent Application No. 2005-025885 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A room temperature curable organopolysiloxane composition comprising
(A) 100 parts by weight of at least one organopolysiloxane selected from the group consisting of an organopolysiloxane having the general formula (1):
HO(R¹₂SiO)ₓH (1)
wherein R¹ is each independently a substituted or unsubstituted monovalent hydrocarbon group and x is an integer of at least 10, an organopolysiloxane having the general formula (2): 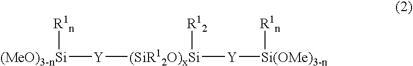
wherein R¹ and x are as defined above, Me is methyl, Y is an oxygen atom or an alkylene group of 1 to 5 carbon atoms, and n is independently an integer of 0 or 1, and an organopolysiloxane having the general formula (3): 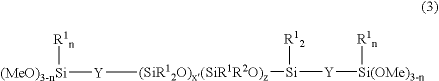
wherein R¹, Me, Y and n are as defined above, R² is a branch chain containing a hydrolyzable group having the general formula (4):
—Y—Si(OMe)₃₋ₙ (4)
wherein Y, Me and n are as defined above, x′ is an integer of at least 9, z is an integer of at least 1, and x′+z=x,
(B) 0.1 to 20 parts by weight of an alkoxysilane compound having on the average at least two silicon-bonded hydrolyzable groups per molecule or a partial hydrolyzate thereof or a mixture thereof,
(C) 0.5 to 15 parts by weight of an organoxy titanium having the general formula (5):
Ti(OR³)₄ (5)
wherein R³ is each independently a monovalent hydrocarbon group of 2 to 10 carbon atoms,
(D) 0.01 to 10 parts by weight of an organic compound having at least one hydroxyl group bonded to a benzene ring per molecule, and
(E) 0 to 10 parts by weight of a silane coupling agent,
wherein the color of the composition tinted with components (C) and (D) fades or changes upon curing of the composition, by which a degree of curing is visually observable.

2. The composition of claim 1, wherein component (D) is a phenol, cresol or hydroquinone.

3. The composition of claim 1, further comprising (F) 1 to 500 parts by weight of at least one filler.

4. The composition of claim 1, further comprising (G) an inert silicone fluid.
